(19) United States
(12) Patent Application Publication
(10) Pub. No.: US 2007/0009869 A1
(43) Pub. Date: Jan. 11, 2007

(54) Crowd federate architecture and API design

(75) Inventors: Frederic D. McKenzie, Virginia Beach, VA (US); Qingwen Xu, Beijing (CN); Quynh-Anh H. Nguyen, Portsmouth, VA (US); Mikel D. Petty, Huntsville, AL (US)

Correspondence Address: AKERMAN SENTERFITT, P.O. BOX 3188, WEST PALM BEACH, FL, 33402-3188, US

(73) Assignee: Old Dominion Research Foundation, Norfolk, VA (US)

(21) Appl. No.: 11/406,805

(22) Filed: Apr. 18, 2006

Related U.S. Application Data
(60) Provisional application No. 60/672,458, filed on Apr. 18, 2005.

(51) Int. Cl. G09B 19/00

(52) U.S. Cl. 434/236

(57) ABSTRACT

A computer-based simulation system of modeling crowd behavior is provided. The system includes a cognition module based upon a model of cognitive elements representative of a crowd. The system also includes a physical-action module for modeling the context and action attributes of a crowd. The system further includes an application program interface (API) comprising a set of computer-implemented functions for running the cognition module in conjunction with the physical-action module in a pre-selected computing environment.

### CROSS-REFERENCE TO RELATED APPLICATIONS

This application claims the priority of U.S. Provisiorial Application No. 60/672,458, filed Apr. 18, 2005, which is incorporated herein in its entirety.

### STATEMENT REGARDING FEDERALLY SPONSORED RESEARCH OR DEVELOPMENT

The United States Government may have certain rights in this invention pursuant to United States Air Force Grant No. F336 15-03C-6340.

### FIELD OF THE INVENTION

The present invention is related to the fields of simulation and modeling, and, more particularly, computer-based simulations and models.

### BACKGROUND

Military entities and police organizations are increasingly likely to be called upon to deal with crowds, often hostile ones, in a variety of contexts and situations. These situations pose unique challenges, even for professional military and police personnel. Indeed, a crowd confrontation can be one of the more difficult and complex situations that these professionals encounter. Typically, such situations involve wide-spread confusion and frequent interruptions to communications among front-line personnel and between line officers and their commanders. There is frequently the risk that an innocent civilian will be accidentally injured. There is also the risk that a peacekeeper will be unintentionally injured, or, even intentionally injured at the hand of an agitator. Moreover, there is generally the attendant risk that an incident will occur at the tactical level that will have far-reaching consequences for policymakers at the strategic level, especially in the face of extensive media coverage.

Notwithstanding the increasing likelihood that military entities and police organizations will be drawn into these kinds of situations, there has been a dearth of computer-based systems and techniques for modeling and simulating crowd confrontations. Legacy simulations for military operations, understandably, have historically focused instead on large-scale engagements between heavily mechanized forces in primarily non-urban settings.

Accordingly, there is a need for a computer-based system and methods for simulating crowd-centric behavior. The systems and techniques, moreover, must be based upon realistic and sufficiently sophisticated crowd-psychology models if the systems and techniques are to meet the need for adequate training and experimental modeling.

### SUMMARY OF THE INVENTION

The present invention provides a system and methods for computer-based simulation and control of crowd behavior. According to one embodiment, the invention defines a crowd federate architecture and corresponding application program interface (API) design. The federate can be used to provide simulation and control of disparate human action-behaviors in the context of a crowd confrontation or riot. The system and methods can be used, for example, for the purpose of training personnel likely to be engaged in crowd confrontations and for obtaining experimental results through simulation and modeling of crowd behavior. The system and methods also can be used, for example, to obtain experimental results based upon realistic and sophisticated psychological models of crowd behavior.

The present invention, according to still another embodiment, provides a framework in the form of a layered architecture. The architecture is composed of a physical layer in which movements and other actions of a crowd are manifested, and a cognitive layer in which underlying motivations for these activities are generated and propagated. Both layers are connected via an API layer that provides mapping and communication services for the stimuli, activities, and accompanying parameters that define and characterize crowd-centric behavior.

One embodiment of the present invention is a computer-based simulation system of modeling crowd behavior. The system can include a cognition module based upon a model of cognitive elements representative of a crowd, as well as a physical-action module for modeling the context and action attributes of a crowd. The system further can include an API comprising a set of computer-implemented functions for running the cognition module in conjunction with the physical-action module in a pre-selected computing environment.

Yet another embodiment of the present invention is a computer-based method of crowd simulation and control. The method can include instantiating a cognition module based upon a model of cognitive elements representative of a crowd. The method also can include instantiating a physical-action module that models the context and action attributes of a crowd. The method further can include implementing simulation and control by running the cognition module in conjunction with the environmental module in a pre-selected computing environment using an API comprising a set of computer-implemented functions.

Still another embodiment of the present invention is a computer-readable storage medium. The computer-readable storage medium can comprise computer instructions for instantiating a cognition module based upon a model of cognitive elements representative of a crowd, and instantiating a physical-action module that models the context and action attributes of a crowd. The computer-readable storage medium can further comprise instructions for implementing a set of functions defining an API, the API running the cognition module in conjunction with the environmental module in a pre-selected computing environment and comprising a set of computer-implemented functions.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram of a computer-based simulation system for modeling crowd behavior, according to one embodiment of the present invention.

FIG. 2 is a flowchart illustrating exemplary steps of a computer-based method for crowd simulation and control, according to another embodiment of the present invention.

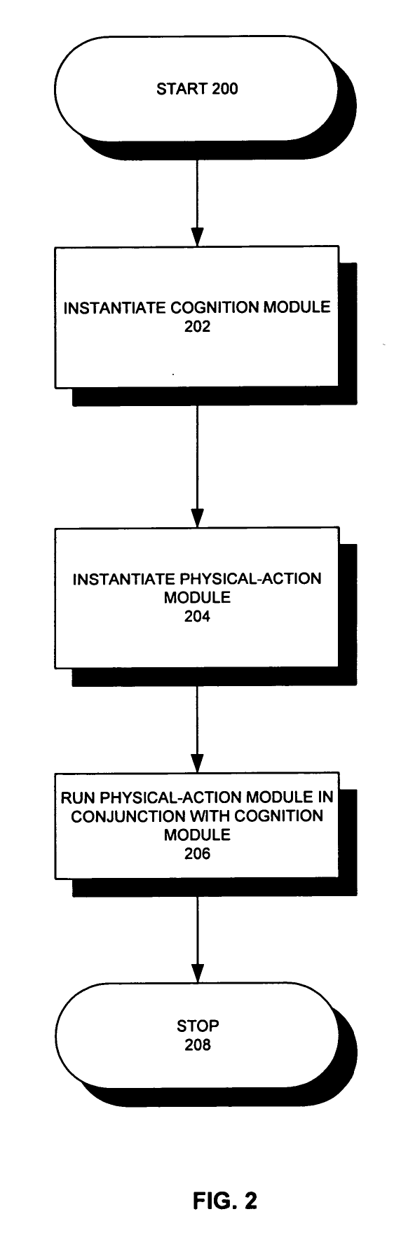

### DETAILED DESCRIPTION OF THE INVENTION

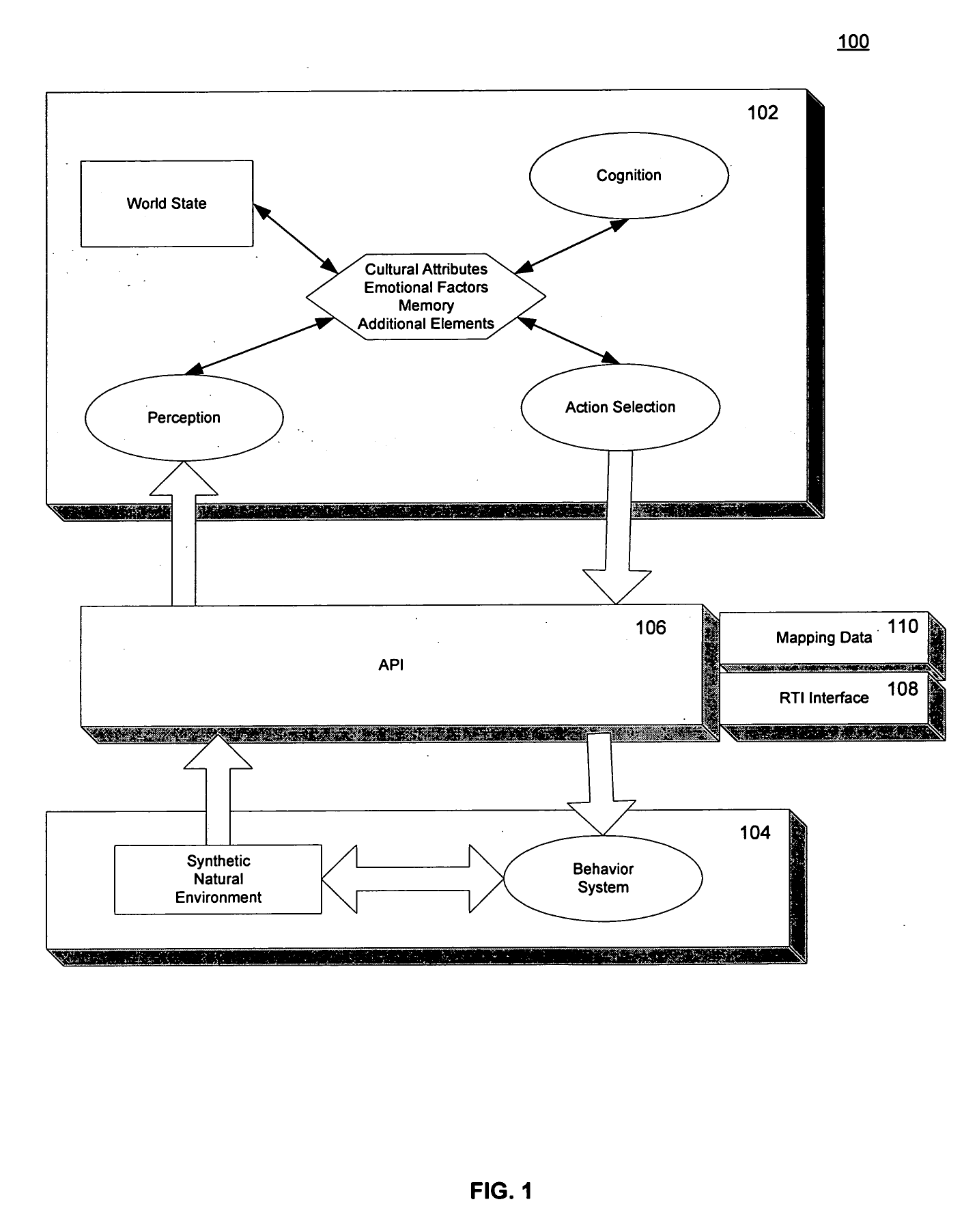

FIG. 1 provides a schematic diagram of a computer-based simulation system 100 for modeling crowd behavior, according to one embodiment of the present invention. As illustrated, the system 100 includes a cognition module 102 that is derived from and/or based upon a model of cognitive elements representative of a crowd. The system 100 also illustratively includes a physical-action module 104 for modeling the context and action attributes of a crowd. The system 100 further includes an API 106 comprising a set of computer-implemented functions for running the cognition module 102 in conjunction with the action module 104 in a pre-selected computing environment (not explicitly shown). Each of the modules can be implemented in software code configured to run on one or more logic-based processing circuits and/or in dedicated hardwired circuitry.

The system 100, according to one embodiment defines a crowd federate. As used herein, the term “federate” includes a member of a high-level architecture federation as well as all applications participating in a computer-based federation. As will be readily understood by one of ordinary skill in the art, a federation can refer to federation managers, data collectors, real-world (“live”) systems (e.g., C⁴, systems, instrumented ranges, sensors), simulations, passive viewers and other utilities. Accordingly, the system 100 also can be compliant with a pre-selected high-level architecture (HLA). The system 100, moreover, can thus communicate and be concurrently run with other federates.

As will be readily understood by one of ordinary skill in the art, the API 106 can be implemented as an interface, generally, that enables one program or module to use facilities provided by another, whether by calling that program or module, or by being called by it. At a higher level, still, the API 106 defines the functionality or, more particularly, a set of functions that are delivered by a programming system running on a computing device. As such, the API 106 optionally can be part of a mix of APIs in a particular system that provides instructions for what the system is to do. Accordingly, the API 106 can be implemented as a set of routines, protocols, and tools for building the crowd behavior models and simulations.

Operatively, the API 106 facilitates control of the physical-action module 104 by the cognition module 102. The API 106, more particularly, can provide at least one event feedback and/or at least one state feedback from the physical-action 104 module to the cognition module 102.

As further illustrated, the system 100 optionally further includes a run-time interface (RTI) 108 in communication with the API 106 for providing common interface services during a run time of a predefined high-level architecture federation. As will also be readily understood by one of ordinary skill in the art, the RTI 108 can be implemented in middleware as needed when implementing a High Level Architecture. Accordingly, the RTI 108 can be implemented so as to conform, for example, to IEEE 1516 and/or HLA 1.3, or other API specifications.

The system 100 further can comprise a set of mapping data 110. The API 106, accordingly, can provide access to interaction data as required by the RTI 108. The mapping data 110, moreover, can be reconfigurable. More particularly, the system 100 can define a crowd federate comprising data representative of crowd attributes. Additionally, the data can be exchanged across the RTI 108 with at least one other federate.

The system 100, more fundamentally, provides a reconfigurable architecture and can be used to computationally implement one or more psychologically-based models of crowd behavior. This framework, and the API 106 particularly, facilitates the integration, communication, and interoperability of robust cognitive models of crowd behavior with physical models of a crowd.

More particularly, the API 106 facilitates control of one or more physical models implemented by the physical-action module 104 based on and/or responsive to one or more behavioral models implemented with the cognition module 102. The API 106, as noted, can provide access to each entity and interaction data required by the RTI 108. Accordingly, the API 106 facilitates the exchange of information between two module-implemented models influenced by the reconfigurable mapping data.

The system 100 generally provides functionality that can be mapped to any give cognitive or physical model implemented by the respective modules 102, 106. The API 106 provides a mechanism by which functionality and information are conveyed given a set of mappings. As illustrated, the cognition module 102 can include perception and action-selection components that interact with the physical model implemented by the physical-action module 104 through the API 106. The API 106 can include a mechanism to provide sensory data to the cognitive model implemented by the cognition module 102, as well as a mechanism to provide to the cognition module 102 command and control over the physical-action module 104 and vice versa. Sensor stimuli can be provided to the cognition module 102 and action can be provided by the cognition module 104 to actuate simulate actions via the API 106.

Specifications of the system 100 and interface, moreover, can be derived and refined based on general cognitive and physical designs derived from crowd modeling literature, an implemented prototype, and experiments. An advantage of the flexibility of the system 100, provided particularly by the API 106, is to support simulation of changing crowd behavior psychology. Characters and groups of characters can be defined by a set of attributes and a set of actions to be carried out by the groups as well as the characters in the groups. Such distinctions allow individual characters to carry out individualized actions while sharing actions designated as group activities with members of a group. The ability to perceive and affect characters and their environment is provided through the execution of a predetermined set of crowd behavior actions that can be mapped to similar actions modeled by the cognition and physical-action modules 102, 104.

In modeling and simulating crowd behavior with the system 100, a simulation entity represents an individual or group of individuals that are simulated by the particular set of computational models implemented. An entity type of a simulation entity can define a set of actions and stimulus that the simulation entity may take or experience. Actions and stimulus in the form of requests can be transferred between the computational modules that implement the models.

The physical model implemented with the physical-action module 104 can provide realistic locomotion actions of a simulation entity. The results of a locomotion action can include update position and orientation of the simulation entity. The locomotion actions can be selected and controlled by the cognition model of the simulation entity implemented by the cognition module 102. The physical model implemented by the physical-action module 104 can also provide sensing information or stimulus to the cognition module 102 for processing. The cognition model implemented by the cognition module 102 performs cognitive tasks and produces actions that can be compared to data from human performance.

The computational processes implemented can include perception, knowledge, representation, decision making, learning, and action selection. Accordingly, as implemented with the system 100, the cognitive model receives stimulus that is provided by the corresponding physical model and produces actions that are simulated by the physical-action module 104.

The API 106, according to one embodiment, can be implemented in a plurality of software-based API classes. A crowd API class can provide a main interaction point between the modules that implement the different models. A control interface can provide initialization and simulation run-time control functionalities. A model interface can provide registration, type, and entity creation along with forwarding functionalities. A crowd API object can contain a type system of the simulation. The type system can be created during API initialization. More particularly, each simulation entity type can be defined in the type system and can have a corresponding entity type that specifies the actions and stimulus of the simulation entity.

An API type class can define the entity, action, and stimuli of a simulation. The API type class can provide common information for each type, such as name or category. An entity type can track all simulation entities in the simulation that have a particular type. The API type class can contain a list of action types, a list of stimuli types, and a list of API objects. The types in the system can be specified in a Crowd Behavior Object Model (CBOM) file and can be created by a TypeFactory object.

A TypeFactory object can read the CBOM file and create an API type object for each type defined in the file. The TypeFactory class can realize an Abstract Factory pattern that supports multiple type standards, isolates type creation from type specification, enforces dependencies between actions and stimulus in a type, but is not required to support run-time type creation. An entity type, according to one embodiment, can be self-extending to form a new type at run time. The new type need only be slightly different from the original type. The API type class can realize a prototype pattern that supports run-time API type creation and reduces the number of classes and/or subclasses in the system 100 in order to support a type extension capability.

An API object class represents an abstract concept class that represents the simulation entity in the API 106. It provides general information of the simulation entity and contains information such as name, type, and handle of a simulation entity. It also contains information about the computation models implemented by the modules 102, 104 that simulate the simulation entity. A simulation entity, as already noted, can be an individual or group of individuals. To support this hierarchical structure of the simulation entity, the API object class can realize a composite pattern that presents part-whole hierarchies of entities and provides a uniform interface to individual and group classes.

Another class, designated an API Xmitor class, is an abstract class that represents the simulation entity requests (i.e., stimulus, actions, etc.). An API Xmitor class specifies a request that can be sent from one module to another during simulation. It provides detailed information of the exchanged requests between the cognition module 102 and the physical-action module 104. The action/stimuli request can be encapsulated in an API Xmitor class to support parameterized request objects and allow the module-implemented physical model and cognitive models to be structured around a high-level operation. According to still another embodiment, the system 100 permits different request formats for different module-implemented models. In this embodiment, request converting takes place before the request is sent or after it is received by a module 102, 104. A converter class can provide request format conversion between different modules 102, 104 and an API executive. The converter class can realize a builder pattern that provides an independent algorithm for converting action or stimuli and that supports different representations of actions or stimuli.

According to still another embodiment, an abstract class designated a communication API class provides an abstract communication class that implements communication mechanisms. It can serve as a placeholder that indicates that the API 106 will have cross-machine or cross-process communication capabilities.

Yet another embodiment of the present invention is a computer-based method 200 of crowd simulation and control. Exemplary steps of the method 200 are illustrated by the flowchart of FIG. 200.

The method 200 illustratively includes, at step 202, instantiating a cognition module 102 based upon a model of cognitive elements representative of a crowd. At step 204, the method 200 further illustratively includes instantiating a physical-action module 104 that models the context and action attributes of a crowd. Illustratively, the method 200 additionally includes at step 206 implementing simulation and control by running the cognition module 106 in conjunction with the physical-action module in a pre-selected computing environment using an application program interface (API), which can comprise a set of computer-implemented functions. The method 200 illustratively concludes at step 208.

Optionally, the method 200 can further comprise providing at least one event feedback and/or at least one state feedback from the physical-action module 104 to the cognition module 102 using the API 106. The method 200 also optionally can include providing common interface services during a run time of a predefined high-level architecture federation using a run-time interface (RTI) in communication with the API 106. Additionally, the method 200 optionally can further include providing access to interaction data as required by the RTI using the API 106. The method 200 further can include providing data representative of crowd attributes, and exchanging the data across the RTI with another federate.

Yet another embodiment of the present invention is a computer-readable storage medium. The storage medium can include computer instructions for instantiating a cognition module based upon a model of cognitive elements representative of a crowd. The storage medium additionally can include instantiating a physical-action module that models the context and action attributes of a crowd. Furthermore, the method can include implementing a set of functions defining an application program interface (API) for running the cognition module in conjunction with the environmental module in a pre-selected computing environment using an application program interface (API) comprising a set of computer-implemented functions.

The present invention can be realized in hardware, software, or a combination of hardware and software. The present invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein.

The present invention also can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

That claimed is:

1. A computer-based simulation system of modeling crowd behavior, the system comprising:
a cognition module based upon a model of cognitive elements representative of a crowd;
a physical-action module for modeling the context and action attributes of a crowd;
an application program interface (API) comprising a set of computer-implemented functions for running the cognition module in conjunction with the physical-action module in a pre-selected computing environment.

2. The system of claim 1, wherein the system defines a crowd federate.

3. The system of claim 1, wherein the system is compliant with a pre-selected high-level architecture (HLA).

4. The system of claim 1, wherein the API facilitates control of the physical-action module by the cognition module.

5. The system of claim 4, wherein the API provides at least one of an event feedback and a state feedback, the feedback being from the physical-action module to the cognition module.

6. The system of claim 1, further comprising a run-time interface (RTI) in communication with the API for providing common interface services during a run time of a predefined high-level architecture federation.

7. The system of claim 6, further comprising a set of mapping data, the API providing access to interaction data as required by the RTI.

8. The system of claim 7, wherein the mapping data is reconfigurable.

9. The system of claim 7, wherein the system defines a crowd federate comprising data representative of crowd attributes, and wherein the data is exchanged across the RTI with at least one other federate.

10. A computer-based method of crowd simulation and control, the method comprising:
instantiating a cognition module based upon a model of cognitive elements representative of a crowd;
instantiating a physical-action module that models the context and action attributes of a crowd;
implementing simulation and control by running the cognition module in conjunction with the environmental module in a pre-selected computing environment using an application program interface (API) comprising a set of computer-implemented functions.

11. The method of claim 10, further comprising providing at least one of an event feedback and a state feedback, the feedback being provided from the physical-action module to the cognition module using the API.

12. The method of claim 10, providing common interface services during a run time of a predefined high-level architecture federation using a run-time interface (RTI) in communication with the API.

13. The method of claim 12, further comprising providing access to interaction data as required by the RTI using the API.

14. The method of claim 13, further comprising providing data representative of crowd attributes, and exchanging the data across the RTI with a pre-selected federate.

15. A computer-readable storage medium, the storage medium comprising computer instructions for:
instantiating cognition module based upon a model of cognitive elements representative of a crowd;
instantiating a physical-action module that models the context and action attributes of a crowd;
implementing a set of functions defining an application program interface (API) for running the cognition module in conjunction with the environmental module in a pre-selected computing environment using an application program interface (API) comprising a set of computer-implemented functions.

16. The computer-readable storage medium of claim 15, further comprising computer instructions for providing at least one of an event feedback and a state feedback, the feedback being provided from the physical-action module to the cognition module using the API.

17. The computer-readable storage medium of claim 15, further comprising computer instructions for providing common interface services during a run time of a predefined high-level architecture federation using a run-time interface (RTI) in communication with the API.

18. The computer-readable storage medium of claim 17, further comprising computer instructions for providing access to interaction data as required by the RTI using the API.

19. The computer-readable storage medium of claim 18, further comprising computer instructions for providing data representative of crowd attributes, and exchanging the data across the RTI with a pre-selected federate
